(19) United States
(12) Patent Application Publication
(10) Pub. No.: US 2011/0081080 A1
(43) Pub. Date: Apr. 7, 2011

(54) IMAGE PROCESSING DEVICE, DISPLAY DEVICE, IMAGE PROCESSING METHOD, PROGRAM AND RECORDING MEDIUM

(75) Inventors: Hidekazu Miyata, Osaka (JP); Yasukuni Yamane, Osaka (JP)

(73) Assignee: Sharp Kabushiki Kaisha

(21) Appl. No.: 12/737,181

(22) PCT Filed: Jun. 2, 2009
(86) PCT No.: PCT/JP2009/060087

§ 371 Date: Dec. 16, 2010

(30) Foreign Application Priority Data
Aug. 6, 2008 (JP) 2008-203541

(51) Int. Cl. G06K 9/36; G02F 1/13

(52) U.S. Cl. 382/167; 382/276

(57) ABSTRACT

An image processing device of at least one embodiment includes: an upscaling circuit for upscaling resolution of an image signal X (input image data) to high resolution; and a redistribution circuit that redistributes, among a plurality of separate pixels constituting one pixel of the image signal X, a tone value of each of the separate pixels upscaled by the upscaling circuit. With this arrangement, generation of a high-definition image and improvement of a viewing angle are realized by the image processing device that converts resolution of the input image data into high resolution.

### TECHNICAL FIELD

The present invention relates to: an image processing device that upscales resolution of inputted image data to high resolution; and an image processing method.

### BACKGROUND ART

Conventionally, a problem of a viewing angle property of a liquid crystal display panel has been posed. Specifically, luminance and chromaticity obtained when the liquid crystal display panel is viewed from an oblique direction are different from those obtained when the liquid crystal display panel is viewed from a front direction. As shown in FIG. 9, particularly a liquid crystal display panel of a VA mode causes such a problem that luminance of an output signal with respect to luminance of an input signal when the liquid crystal display panel is viewed from the oblique direction is greater than that when the liquid crystal display panel is viewed from the front direction. That is, the problem of excess brightness occurs in the liquid crystal display panel of the VA mode.

A pixel dividing method disclosed in, for example, Patent Literature 1 is generally known as a method for solving the problem concerning such a viewing angle property.

### Citation List

Patent Literature

Patent Literature 1
Japanese Patent Application Publication Tokukaihei No. 4-102830 A (Publication Date: Apr. 3, 1992)

### SUMMARY OF INVENTION

Conventionally, there has been conducted many studies on an upscaling technique of converting resolution of inputted image data into high resolution so that a liquid crystal display panel provides a high-quality image.

Recently, the resolution provided by the liquid crystal display panel has greatly increased, and there has been developed a panel that provides resolution of 4090 pixels (in a horizontal direction)×2160 pixels (in a vertical direction) in high definition formats, the so-called 4K2K panel. For example, assume that an image signal (image data) of 1920×1080 resolution in high definition formats is inputted as input image data to such a liquid crystal display panel. In this case, the liquid crystal display panel performs an upscaling process to display in 3840×2160 resolution that is four times greater than (twice greater both in width and length) the resolution of the input image data.

However, it is difficult to solve the problem of a viewing angle property even if a high-quality image is realized by the upscaling technique. This is because difference in luminance between separate pixels that are obtained by division for improvement of the viewing angle overlaps difference in luminance between the separate pixels after the upscaling process. In this case, it is impossible to improve the viewing angle even if the high-quality image is realized.

As described above, a liquid crystal display panel which not only generates a high-definition image but also improves the viewing angle by carrying out the upscaling process has not yet been realized.

The present invention was made in view of the problem, and an object of the present invention is to attain an image processing device which can generate a high-definition image and improve a viewing angle, by converting resolution of input image data into high resolution.

An image processing device of the present invention, in order to attain the object, includes an upscaling section that upscales resolution of input image data to high resolution; and a redistribution section that redistributes, among a plurality of separate pixels constituting one pixel of the input image data, a tone value of each of the separate pixels upscaled by the upscaling section.

According to the above arrangement, it is possible to redistribute, among a plurality of separate pixels constituting one pixel of the input image data, a tone value of each of the separate pixels upscaled by the upscaling section. It is therefore possible to set the tone values of the separate pixels to be tone values that bring the high-definition image while improving the viewing angle by pixel division. That is, it is possible to simultaneously attain improvement of the viewing angle and high definition of a displayed image. Note that the tone values obtained by the redistribution process performed by the redistribution section are determined by luminance and a pixel size.

As described above, according to the arrangement of the present invention, it is possible to provide the image processing device which can generate a high-definition image and improve a viewing angle.

It is preferable that the redistribution section of the image processing device redistributes the tone value of each of the separate pixels upscaled by the upscaling section in such a manner that a luminance represented by image data corresponding to the separate pixels upscaled by the upscaling section is equal to a luminance represented by redistributed image data corresponding to the separate pixels.

According to the above arrangement, it is possible to attain an image displayed with high definition and an improved viewing angle, without difference in luminance of the upscaled image data before and after redistribution.

An image processing device of the present invention, to attain the object, (i) including an upscaling section for upscaling resolution of input image data to high resolution and (ii) commanding a display section to display an upscaled image, the display section being configured such that one pixel is made up of sub-pixels R, G and B, the image processing device further including a redistribution section that redistributes, among a plurality of separate pixels constituting each of the sub-pixels that make up the one pixel of the input image data, a tone value of each of the separate pixels upscaled by the upscaling section.

According to the arrangement, the image processing device is applicable to a display device in which one pixel is made up of sub-pixels R, G and B, and thus the image processing device can yield the above-described effect.

It is preferable that the redistribution section of the image processing device redistributes the tone value of each of the separate pixels upscaled by the upscaling section in such a manner that a luminance represented by image data corresponding to the separate pixels upscaled by the upscaling section and constituting each of the sub-pixels that make up the one pixel of the input image data is equal to a luminance represented by redistributed image data corresponding to the separate pixels.

According to the above arrangement, the display device in which one pixel is made up of sub-pixels R, G and B also can attain an image displayed with high definition and an improved viewing angle, without difference in luminance of the upscaled image data before and after redistribution.

It is preferable that the redistribution section of the image processing device redistributes the tone value of each of the separate pixels, at distribution ratios determined for the respective sub-pixels.

According to the above arrangement, the sub-pixels can have different redistribution ratios. It is therefore possible to redistribute luminance among the pixels in such a manner that the pixel that gives off a lower luminance has a greater luminance difference. Therefore, it is possible to attain an image displayed with higher definition and an improved viewing angle, without difference in luminance of the upscaled image data before and after redistribution.

A display device of the present invention includes any one of the above-described image processing devices and a display section that displays an image that has been upscaled by the image processing device.

According to the above arrangement, it is possible to generate a high-definition image and to improve a viewing angle.

An image processing method of the present invention including the steps of: upscaling resolution of input image data to high resolution; and redistributing, among a plurality of separate pixels constituting one pixel of the input image data, a tone value of each of the separate pixels upscaled by the upscaling section.

According to the above image processing method, it is possible to attain the effect yielded by the image processing device. That is, according to the above image processing method, it is possible to generate a high-definition image and to improve a viewing angle.

It is preferable that the redistribution step of the image processing method redistributes the tone value of each of the separate pixels upscaled by the upscaling section in such a manner that a luminance represented by image data corresponding to the separate pixels upscaled by the upscaling section is equal to a luminance represented by redistributed image data corresponding to the separate pixels.

According to the above arrangement, it is possible to attain an image displayed with high definition and an improved viewing angle, without difference in luminance of the upscaled image data before and after redistribution.

An image processing method of the present invention (i) including the step of upscaling resolution of input image data to high resolution and (ii) commanding a display section to display an upscaled image, the display section being configured such that one pixel is made up of sub-pixels R, G and B, the image processing method further including the step of redistributing, among a plurality of separate pixels constituting each of the sub-pixels that make up the one pixel of the input image data, a tone value of each of the separate pixels upscaled by the upscaling section.

According to the above arrangement, the image processing method is applicable to the display device in which one pixel is made up of sub-pixels R, G and B, and thus the image processing method can yield the above-described effect.

It is preferable that the redistribution step of the image processing method redistributes the tone value of each of the separate pixels upscaled by the upscaling section in such a manner that a luminance represented by image data corresponding to the separate pixels upscaled by the upscaling section and constituting each of the sub-pixels that make up the one pixel of the input image data is equal to a luminance represented by redistributed image data corresponding to the separate pixels.

According to the above arrangement, the display device in which one pixel is made up of sub-pixels R, G and B also can attain an image displayed with high definition and an improved viewing angle, without difference in luminance of the upscaled image data before and after redistribution.

The image processing device may be realized by a computer. In this case, the present invention encompasses: (i) a program for causing the computer to operate as the above-described sections, so that the above image processing device is realized by the computer; and (ii) a computer-readable recording medium that stores the program.

As described above, an image processing device of the present invention includes a redistribution section that redistributes, among a plurality of separate pixels constituting one pixel of the input image data, a tone value of each of the separate pixels upscaled by the upscaling section.

Further, the image processing method of the present invention includes the step of redistributing, among a plurality of separate pixels constituting one pixel of the input image data, a tone value of each of the separate pixels upscaled by the upscaling section.

Therefore, according to the image processing device and the image processing method of the present invention, it is possible to generate a high-definition image and to improve a viewing angle.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram schematically showing a configuration of a display device including an image processing device in accordance with the present invention.

FIG. 2 is a schematic diagram of explaining a process carried out in the image processing device shown in FIG. 1.

FIG. 3 is a schematic diagram showing a concrete example of the process carried out in the image processing device shown in FIG. 1.

FIG. 4 is a graph showing a luminance property obtained when display is provided based on redistributed image data generated by the image processing device shown in FIG. 1.

FIG. 5 is a view showing another example of the redistributed image data generated by the image processing device shown in FIG. 1.

FIG. 6 is a schematic diagram showing a concrete example of the process carried out in the image processing device shown in FIG. 1 in a case where one pixel is made up of sub-pixels R, G and B.

FIG. 7 is a view separately showing pixels R, G and B shown in FIG. 6.

FIG. 8 is a graph showing a luminance property obtained when display is provided based on redistributed image data, wherein (a) shows a luminance property obtained with restriction on a luminance difference, and (b) shows a luminance property obtained when sub-pixels (R, G, B) have different distribution ratios.

FIG. 9 is a graph showing a luminance property obtained when display is provided based on redistributed image data generated by the conventional image processing device.

### DESCRIPTION OF EMBODIMENTS

The following describes an embodiment of the present invention with reference to drawings.

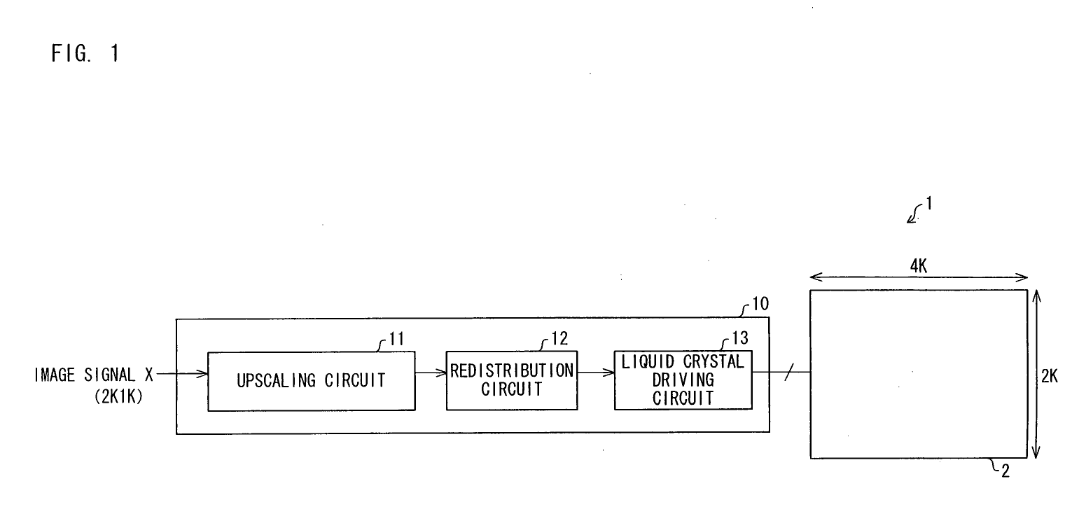

FIG. 1 is a block diagram schematically showing a configuration of a display device 1 in accordance with the present embodiment. As shown in FIG. 1, the display device 1 includes an image processing device 10 and a liquid crystal display panel (display section) 2.

The image processing device 10 includes an upscaling circuit (upscaling section) 11, a redistribution circuit (redistribution section) 12 and a liquid crystal driving circuit 13.

The upscaling circuit 11 upscales an image signal X (image data) inputted to the image processing device 10 and then outputs the upscaled image data to the redistribution circuit 12. The upscaling circuit 11 includes a dividing section (not shown) that divides input image data into separate pieces of image data. In the present embodiment, it is assumed, as an example, that high-definition data of a 2K1K class is inputted to the upscaling circuit 11. The upscaling process will be described in detail later.

The redistribution circuit 12 redistributes luminance of the upscaled image data supplied from the upscaling circuit and then outputs the redistributed image data to the liquid crystal driving circuit 13. The redistribution process will be described in detail later.

The liquid crystal driving circuit 13 controls the liquid crystal display panel 2 on the basis of the redistributed image data supplied from the redistribution circuit 12, so that the redistributed image is displayed on the liquid crystal display panel 2.

Under control of the liquid crystal driving circuit 13, the liquid crystal display panel 2 displays an image corresponding to the image data that has been upscaled and redistributed by the image processing device 10. In the present embodiment, a liquid crystal display panel (of 4K2K class) having 4096 pixels in a horizontal direction and 2160 pixels in a vertical direction is employed. Note that display capacity of the liquid crystal display panel is not limited to this.

In a case where input image data inputted to the image processing device 10 has a size of 1920×1080, and the liquid crystal display panel 2 has a display size of 4096×2160, the input image data is upscaled (enlarged) to 3840×2160 by doubling the respective width and height of the input image data. In this case, the resultant size (3840 dots) in width is smaller than the display size (4096 dots). It is therefore necessary to display the image with a left-hand side area shifted toward a right direction by 128 dots (2048-1920). Any sections of the image processing device 10 may carry out a correction process of shifting the left-hand side area toward the right direction.

In the present embodiment, the liquid crystal display panel is used as the display section. However, the display section is not limited to this. As the display section, for example, a plasma display, an organic EL display, or a CRT may be used. In this case, a display control section appropriate to the display section may be provided instead of the liquid crystal driving circuit 13.

The following describes (i) a concrete process carried out in the image processing device 10 of the present embodiment and (ii) details of the upscaling process and the redistribution process.

As described above, when an image signal of 2K1K is inputted as the input image (original image) data to the image processing device 10 of the present embodiment, the upscaling circuit 11 upscales the input image data to generate the upscaled image data of 4K2K. The redistribution circuit redistributes luminance to the upscaled image data to generate redistributed image data.

Thereafter, the liquid crystal driving circuit 13 generates an image signal corresponding to the redistributed image data in which the luminance has been redistributed by the redistribution circuit 12, and the liquid crystal driving circuit 13 then commands the liquid crystal display panel 2 to display an image corresponding to the thus generated image signal.

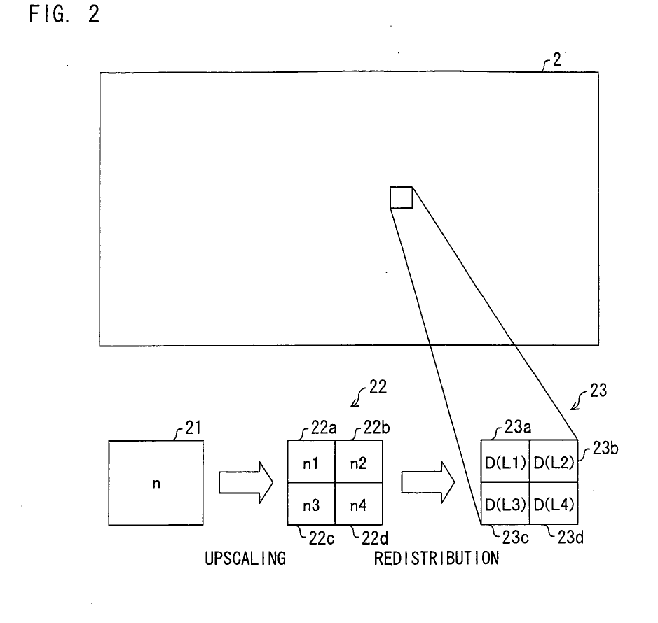

FIG. 2 is a schematic diagram of explaining a process carried out in the image processing device 10. Reference sign 21 shown in FIG. 2 indicates the image data of 2K1K as the input image (original image) data, reference sign 22 indicates the upscaled image data of 4K2K, which has been generated as a result of upscaling by the upscaling circuit 11, and reference sign 23 indicates the redistributed image data, which has been generated as a result of luminance redistribution by the redistribution circuit 12. Further, as shown in FIG. 2, in the present embodiment, one pixel selected from among a plurality of pixels that constitute the input image data is described as an example. Furthermore, it is assumed that the input image data of the one pixel is data of n tone level.

First, the image data 21 of the n tone level is inputted to the upscaling circuit 11 and then upscaled appropriately for four pixels (separate pixels) (to generate upscaled image data). In this embodiment, as shown in FIG. 2, the image data 21 of n tone level is upscaled to pixel data 22a of n1 tone level, pixel data 22b of n2 tone level, pixel data 22c of n3 tone level, and pixel data 22d of n4 tone level.

Subsequently, the upscaled image data is inputted to the redistribution circuit 12, and the redistribution circuit 12 then calculates respective luminance values of the four pixels and a luminance value of one pixel group made up of the four pixels. Specifically, assume that L (K) (cd/m2) is a function to calculate luminance from a tone level. In this case, the luminance values of the four pixels are indicated by L (n1), L (n2), L (n3) and L (n4), respectively, and thus a luminance value LA of the one pixel group is indicated as follows:

LA=(L(n1)+L(n2)+L(n3)+L(n4))/4.

Subsequently, a difference DL between a luminance value of the input image data before upscaling and respective luminance values of the four pixels of the upscaled image data is calculated. The luminance differences DL for the four pixels are expressed as follows:

for a pixel 23a,

DL(n1)=L(n1)−L(M);

for a pixel 23b,

DL(n2)=L(n2)−L(M);

for a pixel 23c,

DL(n3)=L(n3)−L(M); and

for a pixel 23d,

DL(n4)=L(n4)−L(M)

where L (M) is the luminance value of the input image data before upscaling. For example, assume that the luminance values of the four pixels of the upscaled image data satisfy the following relation:

L(n1)>L(n2)>L(n3)>L(n4).

The luminance value L (M) of the input image data before upscaling is expressed by the following equation:

L(M)=(LT(n1)+LT(n2)+LT(n3)+LT(n4))/4

where LT (n1), LT (n2), LT (n3), and LT (n4) are luminances of the four pixels after redistribution, respectively.

Further, when α is a parameter (distribution ratio) that is determined according to luminance and a pixel size, the luminances LT of the four pixels after redistribution satisfy the following relations:

LT(n1)−LT(n2)<α1(LA);

LT(n2)−LT(n3)<α2(LA); and

LT(n3)−LT(n4)<α3(LA),

where α3<α2<α1<α.

As a result, the luminance values L of the four pixels are indicated as follows.

for the pixel 23a,

L1=LT(n1)+DL(n1).

for the pixel 23b,

L2=LT(n2)+DL(n2).

for the pixel 23c,

L3=LT(n3)+DL(n3); and

for the pixel 23d,

L4=LT(n4)+DL(n4).

Furthermore, by a conversion function D (L), the obtained luminance values L are converted respectively into the following tone values D (L1) through D (L4):

for the pixel 23a,

D(L1);

for the pixel 23b,

D(L2);

for the pixel 23c,

D(L3); and

for the pixel 23d,

D(L4).

The tone values thus obtained are outputted to the liquid crystal display panel 2. Consequently, the redistributed image data obtained by redistributing the upscaled image data can be displayed on the liquid crystal display panel 2.

With the respective luminance values L (n1), L (n2), L (n3), and L (n4), each represented by the image data corresponding to each of a plurality of separate pixels upscaled by upscaling in the upscaling section, the luminance values LT (n1), LT (n2), LT (n3), and LT (n4) of the pixels obtained after the redistribution can be determined, as an example, by the following expressions:

LT(n1)=L(n1)+β1×(α×(L(n1)−L(M)));

LT(n2)=L(n2)+β2×(α×(L(n2)−L(M)));

LT(n3)=L(n3)+β3×(α×(L(n3)−L(M))); and

LT(n4)=L(n4)+β4×(α×(L(n4)−L(M)))

where β1, β2, β3 and β4 each are a parameter that indicates a pixel value ratio for making a luminance difference between the separate pixels, and β1+β2+β3+β4=4. Note that the relations between the luminance values of the pixels after the redistribution and the luminance values represented by the pieces of image data of the plurality of separate pixels that have been upscaled by the upscaling section are not limited to the above-described relations.

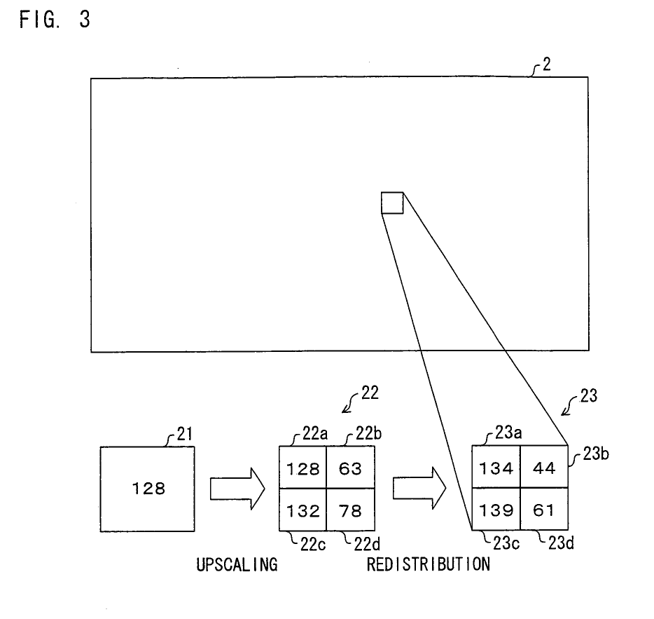

The following describes a concrete example. FIG. 3 shows a state in which the upscaling process is carried out with respect to input image data corresponding to one of a plurality of pixels that constitute the input image data. In this embodiment, it is assumed that the input image data corresponding to the one pixel is data of 128 tone level.

First, the image data of 128 tone level, which is original image data, is inputted to the upscaling circuit 11 and then upscaled appropriately for four pixels (separate pixels) (to generate upscaled image data). In this embodiment, as shown in FIG. 3, the image data of 128 tone level is upscaled to pixel data 22a of 128 tone level, pixel data 22b of 63 tone level, pixel data 22c of 132 tone level, and pixel data 22d of 78 tone level.

The upscaled image data is inputted to the redistribution circuit 12, and the distribution circuit 12 then converts the upscaled image data based on the above-described expressions and redistributes a luminance value. The respective tone values D (L1) through D (L4) of the pixels 23a through 23d after the redistribution are expressed as follows:

D(L1)=134;

D(L2)=44;

D(L3)=139; and

D(L4)=61.

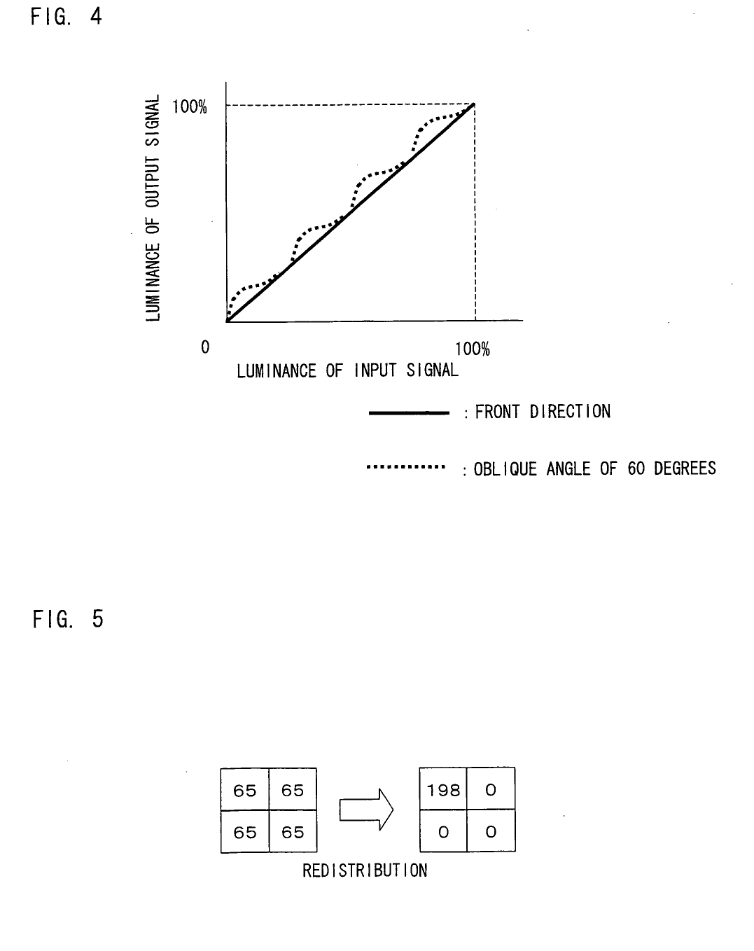

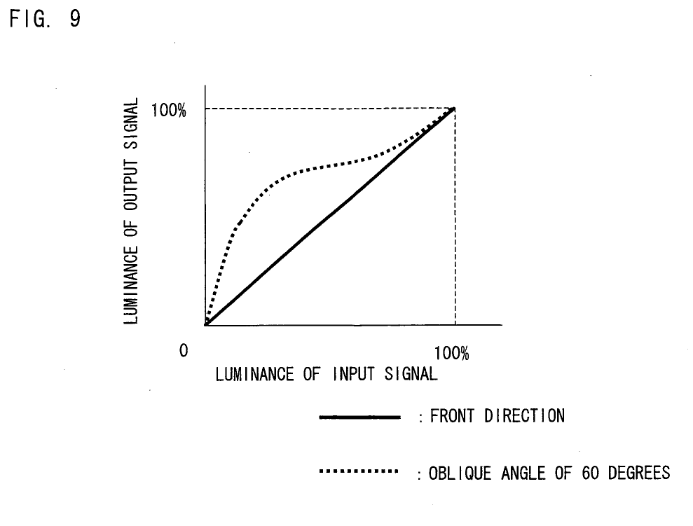

FIG. 4 is a graph showing a luminance property of redistributed image data generated by the image processing device 10 of the present embodiment. FIG. 4 shows luminance of an output display with respect to luminance of an input signal of one pixel that is made up of four pixels (pixels a through d), as with the graph of FIG. 9. As is clear from comparison of FIG. 4 with FIG. 9, in FIG. 4, it is possible to suppress excess brightness that occurs when the liquid crystal display panel 2 is viewed from an oblique angle of 60°. That is, it is possible to make a luminance property obtained when the liquid crystal display panel 2 is viewed from the oblique angle of 60° similar to a luminance property obtained when the liquid crystal display panel 2 is viewed from the front direction. This makes it possible to improve a viewing angle property.

As described above, the parameter α that is set by the conversion process carried out by the redistribution circuit 12 is determined by a function of the luminance and the pixel size. The parameter α is also set such that a luminance difference between separate pixels is increased to an extent that would not bring discomfort with a displayed image. Specifically, it is preferable that the parameter α is set to be 100 cd/m2 or less such that the luminance difference between the separate pixels becomes on the order of 100 cd/m2 in a case where the pixel size is a pixel size that cannot be recognized at a visible distance of 1.5 h (on the order of 0.3 mm×0.3 mm in a case of 65 inches).

As described above, the image processing device 10 of the present embodiment subjects the upscaled image signal to the redistribution process for improving the viewing angle. This makes it possible to attain a high-definition image and to improve the viewing angle. Another example of the redistribution process is shown in FIG. 5. For example, assume that the upscaled pieces of data are such that luminances of four pixels are identical to one another. In this case, redistribution is carried out in such a manner that only one of the four pixels has an extremely high luminance, i.e. the only one pixel of the four pixels has 198 tone level while the other pixels each have 0 tone level. This yields a maximum effect of improving the viewing angle.

However, in the case where only one of the four pixels has an extremely high luminance, a definition of the resulting image is reduced. Further, after the upscaling process is carried out, the four pixels do not necessarily have identical values. Instead, the four pixels possibly have different values. Therefore, in order to improve the viewing angle while maintaining high-definition of upscaled image data, it is preferable that the tone value after the redistribution ranges approximately from 0 to 140 and a luminance difference between the separate pixels is on the order of 100 cd/m2, in a case where a pixel has a size such that a pixel pitch is 0.3 mm.

The above descriptions are given for the arrangement in which the size is quadrupled by upscaling (doubled in width and height). However, this is not the only possibility. As long as the size is increased by a factor of an integer, the same effect as the above-described effect can be attained.

Further, in the above descriptions, it is assumed that the image is displayed in monochrome. However, this is not the only possibility. Alternatively, one pixel may be made up of a plurality of sub-pixels R, G and B. This makes it possible to subject each of the sub-pixels to the same processes as the above-described processes. In this case, a visibility is different depending on colors (R, G, B). It is therefore preferable to set a parameter α (distribution ratio) each for R, G and B. Furthermore, even in the case where the one pixel is made up of R, G and B, it is not necessary to carry out the redistribution process with respect to all of pixels R, G and B. It is possible to carry out the redistribution process with respect to one of the sub-pixels R, G and B, for example, with respect to only a sub-pixel B.

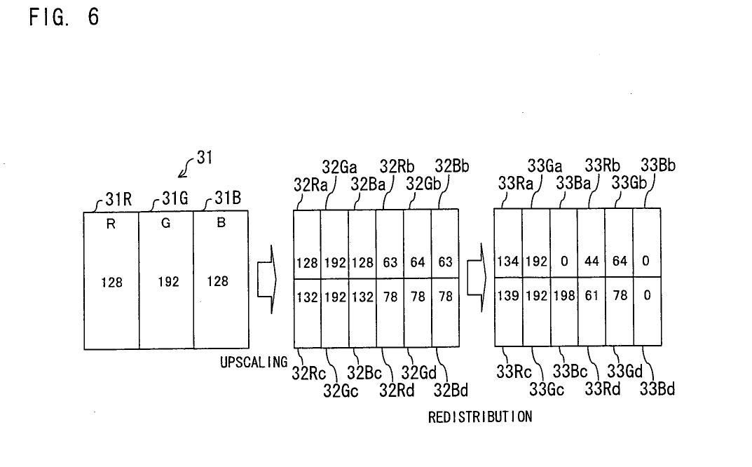

The following describes, as an example, a case where one pixel is divided into sub-pixels R, G and B. FIG. 6 shows a state where an upscaling process is carried out with respect to input image data of one pixel being made up of sub-pixels R, G and B, among a plurality of pixels that constitute the input image data. In this example, it is assumed that the input image data corresponding to the one pixel is made up of: R pixel data of 128 tone level; G pixel data of 192 tone level; and B pixel data of 128 tone level.

First, image data 31, which is original image data and is made up of three sub-pixels, is inputted to the upscaling circuit 11 (see FIG. 1) and then upscaled appropriately for 12 pixels (separate pixels) (to generate upscaled image data). In this case, as shown in FIG. 6, R image data 31R of 128 tone level is upscaled to R pixel data 32Ra of 128 tone level, R pixel data 32Rb of 63 tone level, R pixel data 32Rc of 132 tone level, and R pixel data 32Rd of 78 tone level; G image data 31G of 192 tone level is upscaled to G pixel data 32Ga of 192 tone level, G pixel data 32Gb of 64 tone level, G pixel data 32Gc of 192 tone level, and G pixel data 32Gd of 78 tone level; and B pixel data 31B of 128 tone level is upscaled to B pixel data 32Ba of 128 tone level, B pixel data 32Bb of 63, B pixel data 32Bc of 132 tone level, and B pixel data 32Bd of 78 tone level.

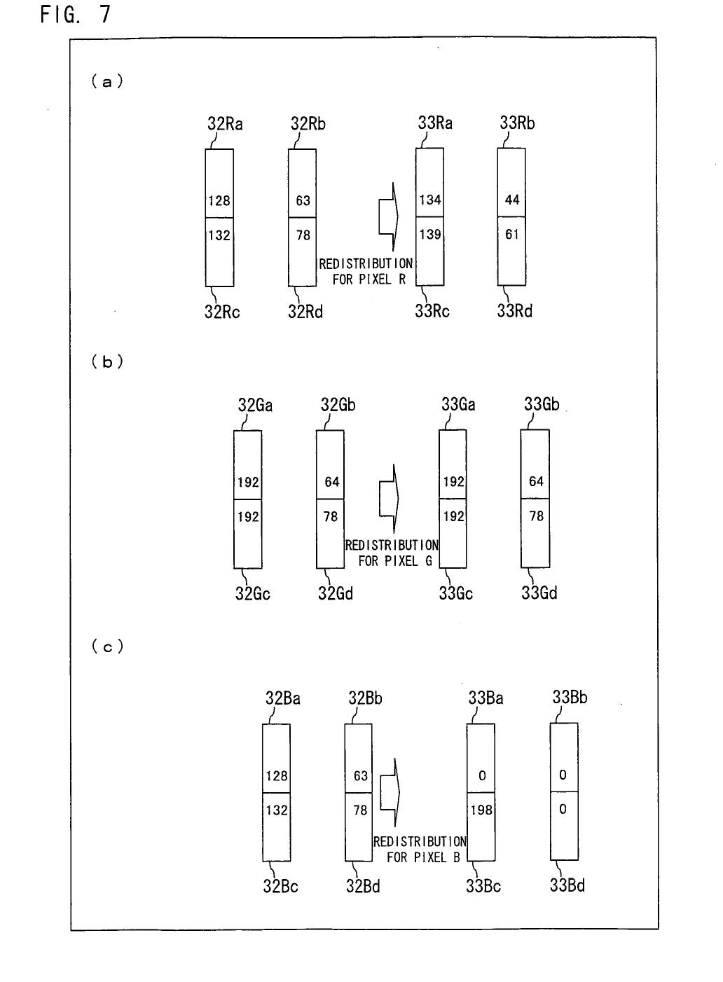

Subsequently, when the upscaled image data is inputted to the redistribution circuit 12 (see FIG. 1), the redistribution circuit 12 converts each of the pixels R, G and B based on the above-described expressions to redistribute a luminance value to the each of the pixels R, G and B, as shown in (a) through (c) of FIG. 7. Tone values D (L1) through D (L12) of the pixels R, G and B after the redistribution are expressed by:

for a pixel 33Ra,

D(L1)=134;

for a pixel 33Rb,

D(L2)=44;

for a pixel 33Rc,

D(L3)=139;

for a pixel 33Rd,

D(L4)=61;

for a pixel 33Ga,

D(L5)=192;

for a pixel 33Gb,

D(L6)=64;

for a pixel 33Gc,

D(L7)=192;

for a pixel 33Gd,

D(L8)=78;

for a pixel 33Ba,

D(L9)=0;

for a pixel 33Bb,

D(L10)=0;

for a pixel 33Bc,

D(L11)=198; and

for a pixel 33Bd,

D(L12)=0.

As described above, in the case where the one pixel is made up of the sub-pixels R, G and B, it is possible to set each distribution ratio of the sub-pixels and to carry out the redistribution process with respect to the each of the sub-pixels. Further, since the sub-pixels give off different luminances, it is possible to suppress difference in luminance of the one pixel before and after redistribution even in a case where the luminance difference between the separate pixels is as great as not less than 100 cd/m2. Consequently, it is possible to carry out the redistribution process even in the case where the luminance difference between the separate pixels is such a great luminance difference.

Further, since the redistribution process can be carried out with respect to each of the sub-pixels, it is possible to configure the redistribution circuit 10 such that whether or not the redistribution process is to be carried out is selected for each sub-pixel by a on/off switch.

Specifically, according to CIE color specification system, the luminance ratio of RGB is indicated as follows:

L (pixel R):L (pixel G):L (pixel B)=1:4.5907:0.0601.
It is therefore possible to redistribute luminance among the pixels R, G and B in such a manner that the pixel B that gives off a lower luminance has a greater luminance difference.

This makes it possible to achieve an image displayed with higher definition and a much-improved viewing angle, without difference in the luminance of the upscaled image data before and after redistribution.

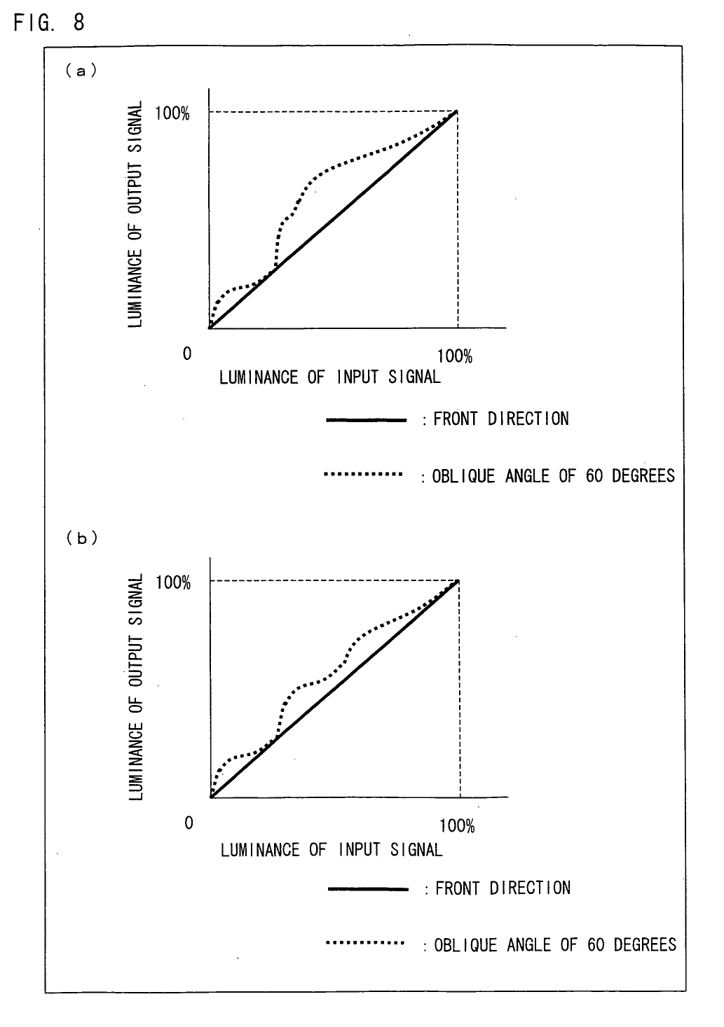

FIG. 8 is a graph showing a luminance property obtained when display is provided based on redistributed image data. (a) of FIG. 8 shows a luminance property obtained with restriction on the luminance difference, that is, a luminance property obtained when the sub-pixels R, G and B have identical distribution ratios. (b) of FIG. 8 shows a luminance property obtained when the sub-pixels R, G, B have different distribution ratios. As is clear from FIG. 8, it is possible to achieve an image displayed with higher definition and a much-improved viewing angle, without difference in luminance of the upscaled image data before and after redistribution in a case where the sub-pixels R, G and B are set to have different distribution ratios.

FIG. 1 shows the liquid crystal driving circuit 13 as one block. However, this is not the only possibility. The liquid crystal driving circuit 13 may be configured with a plurality of blocks. For example, the liquid crystal driving circuit 13 may be configured in the following manner. A plurality of upscaling circuits 11 is provided, and a plurality of redistribution circuits 12 and a plurality of liquid crystal driving circuits 13 are provided accordingly, so that these liquid crystal driving circuits drive divided regions of the liquid crystal display panel 2. In a case where one liquid crystal driving circuit 13 drives the whole liquid crystal display panel 2, it is possible to easily synchronize driving timings of the divided regions with one another. This brings an advantage of an excellent controllability. Meanwhile, this increases the number of pins to be inputted and outputted, thereby causing an increase in a circuit size (IC size). On the other hand, in a case where the plurality of liquid crystal driving circuits 13 are provided so as to be numerically equal to the divided regions, it is possible to yield an advantage of reducing a chip size (Particularly in the present embodiment, the divided regions each are a 2K1K class. It is therefore possible to use a 2K control chip that is used in a conventional 2K1K class display device. This yields an economical advantage). This arrangement, however, requires an arbitration circuit for synchronizing the liquid crystal driving circuits 13.

Further, the circuits (blocks) constituting the image processing device 10 may be attained by software by using a processor such as a CPU. That is, the image processing device 10 may include: the CPU (central processing unit) for executing a command of a control program for realizing functions of the circuits; a ROM (read only memory) that stores the program; a RAM (random access memory) that develops the program; a storage device (storage medium) such as a memory that stores the program and various data; and the like. The object of the present invention can be realized in such a manner that the image processing device 10 is provided with a computer-readable storage medium for storing program codes (such as executable program, intermediate code program and source program) of the control program of the image processing device 10 which control program serves as software for realizing the functions, and that a computer (alternatively, the CPU or a MPU) reads out and executes the program codes stored in the storage medium.

The storage medium is, for example, tapes such as a magnetic tape and a cassette tape, or discs such as magnetic discs (e.g. a Floppy Disc® and a hard disc) and optical discs (e.g. CD-ROM, MO, MD, DVD and CD-R). Further, the storage medium may be cards such as an IC card (including a memory card) and an optical card, or semiconductor memories such as mask ROM, EPROM, EEPROM and flash ROM.

Further, the image processing device 10 may be arranged so as to be connectable to a communication network so that the program codes are supplied to the image processing device 10 through the communication network. The communication network is not particularly limited. Examples of the communication network include the Internet, intranet, extranet, LAN, ISDN, VAN, CATV communication network, virtual private network, telephone network, mobile communication network, and satellite communication network. Furthermore, a transmission medium that constitutes the communication network is not particularly limited. Examples of the transmission medium include (i) wired lines such as IEEE 1394, USB, power-line carrier, cable TV lines, telephone lines and ADSL lines, and (ii) wireless connections such as IrDA and remote control using infrared ray, Bluetooth®, 802.11, HDR, mobile phone network, satellite connections and terrestrial digital network. Note that the present invention can be also realized by the program codes in the form of a computer data signal embedded in a carrier wave, which is the program that is electrically transmitted.

Moreover, the circuits (blocks) of the image processing device 10 may be realized by software. Alternatively, the circuits (blocks) of the image processing device 10 may be configured by hardware logic. A further alternative is a combination of (i) hardware carrying out some of the processes and (ii) computing means controlling the hardware and executing software for the other processes.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to: an image processing device that upscales resolution of input image data to high resolution; and an image processing method.

### REFERENCE SIGNS LIST

1: display device
2: liquid crystal display panel (display section)
10: image processing device
11: upscaling circuit (upscaling section)
12: redistribution circuit (redistribution section)
13: liquid crystal driving circuit
31R, 31G and 31B: sub-pixel (pixel R, pixel G, and pixel B)

1. An image processing device, comprising:
an upscaling section that upscales resolution of input image data to high resolution; and
a redistribution section that redistributes, among a plurality of separate pixels constituting one pixel of the input image data, a tone value of each of the separate pixels upscaled by the upscaling section.

2. The image processing device as set forth in claim 1, wherein:
the redistribution section redistributes the tone value of each of the separate pixels upscaled by the upscaling section in such a manner that a luminance represented by image data corresponding to the separate pixels upscaled by the upscaling section is equal to a luminance represented by redistributed image data corresponding to the separate pixels.

3. The image processing device as set forth in claim 1, wherein:
the redistribution section redistributes the tone value of each of the separate pixels upscaled by the upscaling section in such a manner that a luminance value of the one pixel of the input image data before upscaling is equal to an average of redistributed luminance value of the separate pixels.

4. An image processing device (i) comprising an upscaling section for upscaling resolution of input image data to high resolution and (ii) commanding a display section to display an upscaled image, the display section being configured such that one pixel is made up of sub-pixels R, G and B,
the image processing device further comprising a redistribution section that redistributes, among a plurality of separate pixels constituting each of the sub-pixels that make up the one pixel of the input image data, a tone value of each of the separate pixels upscaled by the upscaling section.

5. The image processing device as set forth in claim 4, wherein:
the redistribution section redistributes the tone value of each of the separate pixels upscaled by the upscaling section in such a manner that a luminance represented by image data corresponding to the separate pixels upscaled by the upscaling section and constituting each of the sub-pixels that make up the one pixel of the input image data is equal to a luminance represented by redistributed image data corresponding to the separate pixels.

6. The image processing device as set forth in claim 5, wherein:
the redistribution section redistributes the tone value of each of the separate pixels, at distribution ratios determined for the respective sub-pixels.

7. The image processing device as set forth in claim 4, wherein:
the redistribution section redistributes the tone value of each of the separate pixels upscaled by the upscaling section in such a manner that a luminance value of each of the sub-pixels of the input image data before upscaling is equal to an average of redistributed luminance value of the separate pixels.

8. A display device comprising:
an image processing device as set forth in claim 1; and
a display section that displays an image that has been upscaled by the image processing device.

9. An image processing method comprising the steps of:
upscaling resolution of input image data to high resolution; and
redistributing, among a plurality of separate pixels constituting one pixel of the input image data, a tone value of each of the separate pixels upscaled by the upscaling section.

10. The image processing method as set forth in claim 9, wherein:
the redistribution step redistributes the tone value of each of the separate pixels upscaled by the upscaling section in such a manner that a luminance represented by image data corresponding to the separate pixels upscaled by the upscaling section is equal to a luminance represented by redistributed image data corresponding to the separate pixels.

11. An image processing method (i) comprising the steps of upscaling resolution of input image data to high resolution and (ii) commanding a display section to display an upscaled image, the display section being configured such that one pixel is made up of sub-pixels R, G and B,
the image processing method further comprising the step of redistributing, among a plurality of separate pixels constituting each of the sub-pixels that make up the one pixel of the input image data, a tone value of each of the separate pixels upscaled by the upscaling section.

12. The image processing method as set forth in claim 11, wherein:
the redistribution step redistributes the tone value of each of the separate pixels upscaled by the upscaling section in such a manner that a luminance represented by image data corresponding to the separate pixels upscaled by the upscaling section and constituting each of the sub-pixels that make up the one pixel of the input image data is equal to a luminance represented by redistributed image data corresponding to the separate pixels.

13. A program for causing a computer to operate as an image processing device as set forth in claim 1, the program causing the computer to function as the sections of the image processing device.

14. A computer-readable recording medium that stores a program as set forth in claim 13.
